(19) United States
(12) Patent Application Publication
(10) Pub. No.: US 2025/0091120 A1
(43) Pub. Date: Mar. 20, 2025

(54) DEVICE AND METHOD FOR PREPARING COOLING WATER ON DEMAND

(71) Applicant: C-TEC CONSTELLIUM TECHNOLOGY CENTER, Voreppe (FR)

(72) Inventors: Pascal HERVIEU, Beaucroissant (FR); Bernard VALENTIN, Voiron (FR); José ORTUNO, Grenoble (FR)

(73) Assignee: C-TEC CONSTELLIUM TECHNOLOGY CENTER, Voreppe (FR)

(21) Appl. No.: 18/727,391

(22) PCT Filed: Feb. 2, 2023
(86) PCT No.: PCT/FR2023/050139

§ 371 Date: Jul. 9, 2024

(30) Foreign Application Priority Data
Feb. 11, 2022 (FR) FR2201198

(51) Int. Cl. B22D 11/124; B22D 11/22; C02F 1/42; C02F 1/44; C02F 103/16

(52) U.S. Cl. CPC B22D 11/1245; B22D 11/225; C02F 1/42; C02F 1/441; C02F 2001/425; C02F 2103/16; C02F 2209/06

(57) ABSTRACT

A preparation method for preparing cooling water which aims to reproduce a target cooling water by using at least two aqueous solutions selected from an industrial water solution, a cationic ion exchange resin-treated water solution, a demineralized water solution and an aqueous solution containing Mg²⁺ and Ca²⁺ ions; a casting method using the cooling water obtained according to the preparation method; and a casting device (100) including the preparation device.

### TECHNICAL FIELD OF THE INVENTION

The present invention relates to a method for preparing a cooling water intended to cool a product during a metallurgical transformation operation and in particular for casting applications of cast parts, for example in a method for casting a product, preferably made of an aluminum alloy. The invention also relates to a casting device comprising a device for preparing a cooling water.

### PRIOR ART

It is known from the prior art (Gildemeister D., Light Metals 2014, pp 885-891), that the composition of a cooling water intended for a metallurgical transformation process could have an effect on the cooling process. In particular, during the formation of a semi-continuous cast plate, the use of a cooling water with an uncontrolled and/or unsuitable composition could generate negative effects on the formation of the plate such as: cracks, slits, excessive curvatures of the foot of the plate, swelling which might block the casting process, or cause liquid metal breakthrough, etc. Although the influence of each constituent parameter of the cooling water is still not completely known, it has already been demonstrated that the alkalinity (characterized by the P-alkalinity (TA) and the M-alkalinity (CAT)), the hardness (characterized for example by the Hardness (TH)), the pH, the conductivity, or the turbidity, had an impact on the heat transfer.

Thus, there is a need to be able to vary the parameters of the cooling water in order to be able to study their effect and, where appropriate, be able to use an optimized water. Indeed, there is a need to be able to control the quality of the water at the beginning of the semi-continuous casting process and to be able to use a cooling water that is different from the water available on the industrial site.

In addition, before implementing a metallurgical transformation process on an industrial scale, it is frequent to carry out cooling tests by simulation or by actual tests, to determine the suitable cooling conditions for a given industrial water. Nonetheless, once these cooling conditions have been determined, they generally cannot be transposed to all industrial waters, which makes it difficult to transfer a metallurgical transformation process from one industrial site to another industrial site.

Moreover, since the testing means for determining cooling conditions are not systematically present on the production site, one solution might consist in carrying out these tests on a site other than the production site and remote from the latter. However, this solution requires supplying, on this other site, a sufficient amount of water from the production site. The major problem of such a supply of cooling water is that a large volume is necessary, which implies obvious logistics and cost problems. In addition, modifications of the composition of the cooling water might happen during transport.

Thus, there is a need to be able to have a cooling water on demand, for the tests implemented during the determination of the cooling conditions, which is a faithful reproduction of the cooling water that will be used afterwards on the production site. Alternatively, there is also a need to be able to have a casting cooling water with a particular composition allowing having a constant thermal efficiency over time, in particular at the start-up transient phase. Nonetheless, this problem is difficult to solve because the control and the modification of the composition of a water is not easy, in particular when it comes to the concentration of dissolved CaSO₄ and MgSO₄ salts.

### DISCLOSURE OF THE INVENTION

The present invention aims to propose a solution that addresses all or some of the aforementioned problems.

This aim could be achieved by implementing a method for preparing a cooling water for cooling a product during a metallurgical transformation operation and in particular for cast product semi-continuous casting applications, the preparation method comprising the following steps:
a step of analyzing the composition of a target cooling water so as to determine a target final composition (cfc). The analysis result is substantially identical to the target final composition (cfc). According to the invention, the term “substantially” should be understood as likely to involve rounding at least one useful parameter. Indeed, the analysis step allows determining at least one useful parameter selected from the group comprising a calcium concentration (THCa), a magnesium concentration (THMg), a M-alkalinity (TAC), a P-alkalinity (TA), a Hardness (TH), a concentration of chlorides (CCI), sulfates (CS), bromides (CBr), sodium (CNa) ions and a pH. Hence, the target composition (cfc) may be identical to the analysis result or equal to +/−10%, preferably +/−5% of the analysis result.
a step of providing at least one first aqueous solution characterized by a first composition and at least one second aqueous solution distinct from the first aqueous solution and characterized by a second composition, said first aqueous solution and said second aqueous solution being selected from the group composed of:
an industrial water solution,
a cationic ion exchange resin-treated water solution,
a demineralized water solution,
an aqueous solution containing Mg²⁺ and Ca²⁺ ions,
a mixing phase comprising a first mixing step in which a first volume of the first aqueous solution and a second volume of the second aqueous solution are mixed, so as to make a mixing volume of a mixture solution characterized by a mixture composition, and forming all or part of the cooling water, said first volume of the first aqueous solution and second volume of the second aqueous solution being determined by a calculation step (E7) according to said first composition and said second composition,

each of the first composition (c1), the second composition (c2), the mixture composition (cm1), and the target final composition (cfc), is defined by at least one useful parameter selected from the group comprising a calcium concentration (THCa), a magnesium concentration (THMg), a M-alkalinity (TAC), a P-alkalinity (TA), a Hardness (TH), a concentration of chlorides (CCI), sulfates (CS), bromides (CBr), sodium (CNa) ions and a pH,
said calculation step (E7) in which the first volume (V1) of the first aqueous solution and the second volume (V2) of the second aqueous solution are determined according to said at least one useful parameter defining the first composition (c1), said at least one useful parameter defining the second composition (c2), and so that said at least one useful parameter defining the mixture composition (cm1) tends towards said at least one useful parameter defining the target final composition (cfc).

By “Industrial water”, it should be understood an industrial water having a conductivity lower than or equal to 2,000 μS/cm, preferably comprised from 100 μS/cm to 2,000 μS/cm. Preferably, the Hardness of the industrial water is lower than or equal to 80° f (° f French degrees), preferably lower than or equal to 50° f. Industrial water refers to the water used for industrial purposes, as opposed to domestic water and agricultural water.

By “cationic ion exchange resin-treated water solution”, it should be understood a solution with a conductivity higher than or equal to 100 μS/cm, which is either a decarbonated water such that TH≤TAC+3° f, or a permuted water such that TH≤3f, where TH and TAC are respectively the Hardness and the P-alkalinity of the considered cationic ion exchange resin-treated water solution expressed in French degrees.

By “demineralized water solution”, it should be understood a solution having conductivity lower than or equal to 100 μS/cm. The demineralized water is a water which no longer contains any ion in solution (such as Ca2+ or HCO3−, etc.), or dissolved neutral mineral substances (aluminum (Al(OH)3) or iron (III) (Fe(OH)3) hydroxides, dissolved silica (Si(OH)4), etc.). The Hardness of the demineralized water is lower than or equal to 1° f.

By “aqueous solution containing Mg²⁺ and Ca²⁺ ions”, it should be understood a solution whose conductivity is higher than or equal to 20 μS/cm, and such that its Hardness TH is higher than 50° f. Preferably, the hydrometric titer TH of the aqueous solution containing Mg²⁺ and Ca²⁺ ions is at least five (5) times as high as the hydrometric titer of the industrial water solution. By “aqueous solution containing Mg²⁺ and Ca²⁺ ions”, it should be understood a solution whose concentration of Mg²⁺ and Ca²⁺ ions is higher than the concentration of Mg²⁺ and Ca²⁺ ions of the industrial water solution, the cationic ion exchange resin-treated water solution, the demineralized water solution. Moreover, and advantageously, the use of the aqueous solution containing Mg²⁺ and Ca²⁺ ions allows producing more easily and on demand, a cooling water having a composition close to the target final composition. Indeed, the use of the aqueous solution containing Mg²⁺ and Ca²⁺ ions is particularly advantageous when there is a need for a harder water than the available industrial water, or to stabilize a water composition with regards to seasonal variations.

The previously-described arrangements allow proposing a method for preparing a cooling water having a composition close to a target final composition.

The preparation method may also have one or more of the following features, considered separately or in combination.

According to one embodiment, the supply step comprise providing a third or a fourth aqueous solution selected so as to be distinct from one another and distinct from the first aqueous solution and the second aqueous solution, said third or fourth aqueous solution being selected from the group composed of:
the industrial water solution,
the cationic ion exchange resin-treated water solution,
the demineralized water solution,
the aqueous solution containing Mg²⁺ and Ca²⁺ ions,

In this case, the first mixing step comprises mixing the third and/or fourth aqueous solution with the first and second aqueous solutions. Hence, it should be understood that the phase of mixing the first volume of the first aqueous solution and the second volume of the second aqueous solution is not restrictive and that it may also comprise mixing a number of volumes of distinct aqueous solutions greater than two.

According to one embodiment, the cooling water is obtained by mixing four volumes of aqueous solutions, each volume of aqueous solution originating respectively from the industrial water solution, from the cationic ion exchange resin-treated water solution, from the demineralized water solution, and from the aqueous solution containing Mg²⁺ and Ca²⁺ ions.

According to one embodiment, the target final composition corresponds to the composition of a cooling water available on an industrial production site, for example a cast part production site.

According to one embodiment, the calculation step is implemented by a calculation unit configured to calculate the first volume of the first aqueous solution and the second volume of the second aqueous solution so as to minimize a difference between said at least one useful parameter defining the mixture composition and said at least one useful parameter defining the target final composition. Thus, advantageously, the calculation unit allows making priority choices on the accuracy of one of the useful parameters relative to others. In this manner, it is possible to implement the preparation method in the case where there is no unique or exact mathematical solution for the preparation of the cooling water having a composition close to the target final composition.

According to one embodiment, each of the first composition, the second composition, the mixture composition, and the target final composition, is defined by a plurality of useful parameters, the calculation step may then be implemented by weighting each useful parameter of said plurality of useful parameters by a weighting coefficient.

According to one embodiment, the mixing phase comprises:
a step of controlling the mixture composition, in which an intermediate value of said at least one useful parameter defining the mixture composition is determined, so as to calculate an initial deviation between said intermediate value and a target value of said at least one useful parameter defining the target final composition
in the case where the initial deviation is higher than a threshold deviation, the mixing phase comprises a second mixing step in which at least one correction element selected from the group composed of a volume of the industrial water solution, a volume of the cationic ion exchange resin-treated water solution, a volume of the demineralized water solution, a volume of the aqueous solution containing Mg2+ and Ca2+ ions, a mass of salt, and a mass of pH correctors, is mixed with the mixture solution so as to make a corrected mixing volume of a corrected mixture solution characterized by a corrected mixture composition which is defined by at least one useful parameter, said at least one correction element being selected so that a corrected deviation between a corrected value of said at least one useful parameter defining the corrected mixture composition and said target value is lower than the initial deviation.

According to one embodiment, the second mixing step is implemented as long as the corrected deviation is higher than the threshold deviation. According to one embodiment, the control step comprises determining the corrected deviation. According to one embodiment, the threshold deviation may be equal to 10% of the target value.

According to one embodiment, at least one mixing step among the first mixing step and the second mixing step is implemented so as to maintain the corrected mixture solution at a temperature comprised between 10° C. and 35° C., preferably between 12° C. and 30° C.

According to one embodiment, the preparation method further comprises a step of providing at least one additive element selected from the group comprising salts and pH correctors, the first mixing step further comprising mixing an additive element mass, said additive element mass being determined according to the first composition and the second composition, and the target final composition.

According to one embodiment, the salts and pH correctors comprise: sodium chloride NaCl, sodium bicarbonate NaHCO₃, sodium carbonate Na₂CO₃, calcium chloride CaCl₂, magnesium sulfate MgSO₄, magnesium chloride MgCl₂, and sodium bromide NaBr.

According to one embodiment, the mass of additive element is diluted in an aqueous solution before the first mixing step during a dilution step. For example, the mass of additive element may be diluted in a portion of the demineralized water solution.

According to one embodiment, the cationic ion exchange resin-treated water solution is a decarbonated water obtained according to the following steps:
a step of providing a cation exchanger comprising a weak cationic ion exchange resin, said cation exchanger being configured to vary between a regenerated configuration in which said weak cationic ion exchange resin is able to capture calcium Ca²⁺ or magnesium Mg²⁺ divalent cations and a charged configuration in which said weak cationic ion exchange resin forms a reserve of calcium Ca²⁺ or magnesium Mg²⁺ divalent cations;
a weak cationic ion exchange resin absorption step in which a portion of the industrial water solution flows in the cation exchanger to make it vary from the regenerated configuration into the charged configuration;
a degassing step in which a water coming out of the cation exchanger is degassed, so as to obtain the decarbonated water.

According to one embodiment, said weak cationic ion exchange resin is able to capture calcium Ca²⁺ or magnesium Mg²⁺ divalent cations bonded to carbonate or bicarbonate ions. In this case, the degassing step comprises degassing a water charged with dissolved carbonic acid (originating from the calcium and magnesium carbonates and bicarbonates) coming out of the cation exchanger. According to one embodiment, the degassing step is implemented naturally, by leaving the water coming out of the cation exchanger in the open air. According to one embodiment, the degassing step is implemented in a degassing column. According to one embodiment, the degassing step is implemented by subjecting the water coming out of the cation exchanger to successive cascades, or by blending, stirring, bubbling, or by the use of a streaming degassing column in which counter-flow air is injected.

According to one embodiment, the cationic ion exchange resin-treated water solution is a permuted water obtained according to the following steps:
a step of providing a cation exchanger comprising a strong cationic ion exchange resin, said cation exchanger being configured to vary between a regenerated configuration in which said strong cationic ion exchange resin is able to capture calcium Ca²⁺ or magnesium Mg²⁺ divalent cations and a charged configuration in which said strong cationic ion exchange resin forms a reserve of calcium Ca²⁺ or magnesium Mg²⁺ divalent cations;
a strong cationic ion exchange resin absorption step in which a portion of the industrial water solution flows in the cation exchanger to make it vary from the regenerated configuration into the charged configuration, and so as to obtain the permuted water, free of Ca2+ and Mg2+ cations.

According to one embodiment, said strong cationic ion exchange resin is able to capture calcium Ca²⁺ or magnesium Mg²⁺ divalent cations bonded to carbonate or bicarbonate ions. The use of a strong cationic ion exchange resin to obtain the cationic ion exchange resin-treated water solution is advantageous in the case where the industrial water solution is barely calcareous and has a low alkalinity. It is possible to use a salt regeneration mode (softener type) or a dilute strong acid regeneration mode (cations totally permuted by H3O+ ions). In the case where a salt regeneration mode is used, like NaCl or Na2SO4, the permuted water may also be referred to as “softened water”. The softened water is a water in which the Ca2+ and Mg2+ cations have been replaced by Na+ originating from the resin. In the case where a dilute strong acid regeneration mode is used, the permuted water could also be called “water, all of the cations of which are permuted by hydronium H₃O+ ions”. This water is a water in which the Ca2+ and Mg2+ cations have been replaced by the hydronium H3O+ ions originating from the resin.

According to one embodiment, the strong cationic ion exchange resin absorption step comprises a step of detecting the charge level, in which a measurement of the variation of the pH or of another parameter of the water present at the outlet of the cation exchanger is carried out, so as to deduce therefrom (for example for future cycles) the charge level of the cation exchanger at all times.

According to one embodiment, the demineralized water solution is obtained by a demineralization step in which a portion of the decarbonated water or permuted water solution is demineralized by a reverse osmosis or ion exchange process on a demineralization resin so as to obtain the demineralized water solution. The demineralization process conventionally includes an operation of permutation on the strong cationic ion exchange resin, degassing and an operation of permutation of the anions on one or two anionic resin(s) (depending on the composition of water and in particular its alkalinity). Preferably, if permuted water obtained by a diluted strong acid regeneration technique is used, the step of permutation on a cationic ion exchange resin is not necessary to obtain the demineralized water.

According to one embodiment, the aqueous solution containing Mg²⁺ and Ca²⁺ ions is obtained during an elution step in which a strong acid is circulated in the cation exchanger, so that Mg²⁺ and Ca²⁺ ions captured by the weak cationic ion exchange resin or by the strong cationic ion exchange resin are dissolved, so as to make the aqueous solution containing Mg²⁺ and Ca²⁺ ions.

According to one embodiment, the elution step comprises a measurement step in which a pH of the aqueous solution containing Mg²⁺ and Ca²⁺ ions is measured, so as to optimize the used amount of acid, and so as to optimize the regeneration of the cation exchanger.

According to one embodiment, an amount of strong acid added during the elution step is defined relative to a volume of weak or strong cationic ion exchange resin to be treated. For example, such an amount of strong acid may form part of the technical data of the cationic ion exchange resin used, said data specifying the volume and the concentration of strong acid necessary to regenerate said cationic ion exchange resin.

According to one embodiment, the aqueous solution containing Mg²⁺ and Ca²⁺ ions is obtained by sampling a partial amount of the solution obtained during the elution step. For example, such a partial amount may correspond to an amount of water made at the beginning of the elution step. In this case, the remainder of the water made during the elution step necessary for the regeneration of the cation exchanger, is then treated and discharged. In this manner, it is possible to control and limit the excess strong acid with the aqueous solution containing Mg²⁺ and Ca²⁺ ions when the weak or strong cationic ion exchange resin is completely regenerated. According to one embodiment, the strong acid is hydrochloric acid or sulfuric acid, preferably diluted between 2 and 10% in water. In the case where the strong acid is a sulfuric acid, the aqueous solution containing Mg²⁺ and Ca²⁺ ions obtained in the elution step contains dissolved CaSO₄ and MgSO₄ salts.

According to one embodiment, the elution step is implemented after the weak cationic ion exchange resin absorption step or after the strong cationic ion exchange resin absorption step. Hence, it should be understood that the elution and charging steps allow making the cation exchanger vary alternately between the regenerated configuration and the charged configuration.

According to one embodiment, the preparation method further comprises a second analysis step in which at least one useful parameter of the industrial water solution selected from the group comprising a calcium concentration, a magnesium concentration, a M-alkalinity, a P-alkalinity, a Hardness, and a pH is measured.

According to one embodiment, the second analysis step may be implemented to determine a useful parameter of the cationic ion exchange resin-treated water solution, or on the demineralized water solution, or on the aqueous solution containing Mg²⁺ and Ca²⁺ ions.

The previously-described arrangements allow selecting the aqueous solution(s) having the most suitable composition to serve as a basis for making a mixture solution having a mixture composition that tends towards the target final composition.

The aim of the invention may also be achieved by the use of a cooling water obtained according to the previously-described preparation method, and characterized by said target final composition, to cool a product in a metallurgical transformation step, such as casting, quenching, or hot rolling.

The aim of the invention may also be achieved by implementing a method for casting a product, preferably made of an aluminum alloy, comprising the following steps:
(a) preparing a liquid metal bath, preferably made of aluminum alloy comprising, in % by weight, Cu: 0-6.0; Mg: 0-8; Si 0-12; Zn 0-12; others ≤3 each and ≤10 in total, the remainder aluminum,
(b) casting said liquid metal, preferably by vertical semi-continuous casting, such that, during a casting start phase, a first cooling water characterized by a first mixture composition obtained according to the previously-described preparation method is used.

The casting method according to the invention comprises the previously-described preparation method.

Said first cooling water characterized by a first mixture composition is obtained by a preparation method comprising the following steps:
a step of analyzing the composition of a target cooling water so as to determine a target final composition,
a step of providing at least one first aqueous solution characterized by a first composition and at least one second aqueous solution distinct from the first aqueous solution and characterized by a second composition, said first aqueous solution and said second aqueous solution being selected from the group composed of:
an industrial water solution,
a cationic ion exchange resin-treated water solution,
a demineralized water solution,
an aqueous solution containing Mg²⁺ and Ca²⁺ ions,
a mixing phase comprising a first mixing step in which a first volume of the first aqueous solution and a second volume of the second aqueous solution are mixed, so as to make a mixing volume of a mixture solution characterized by a mixture composition, and forming all or part of the cooling water, said first volume of the first aqueous solution and second volume of the second aqueous solution being determined according to said first composition and said second composition,

each of the first composition (c1), the second composition (c2), the mixture composition (cm1), and the target final composition (cfc), is defined by at least one useful parameter selected from the group comprising a calcium concentration (THCa), a magnesium concentration (THMg), a M-alkalinity (TAC), a P-alkalinity (TA), a Hardness (TH), a concentration of chlorides (CCI), sulfates (CS), bromides (CBr), sodium (CNa) ions and a pH,
a calculation step (E7) in which the first volume (V1) of the first aqueous solution and the second volume (V2) of the second aqueous solution are determined according to said at least one useful parameter defining the first composition (c1), said at least one useful parameter defining the second composition (c2), and so that said at least one useful parameter defining the mixture composition (cm1) tends towards said at least one useful parameter defining the target final composition (cfc).

The preparation method may also have one or more of the features set out before.

The casting method may also have one or more of the following features, considered separately or in combination.

According to one embodiment, the casting method comprises a steady-state casting phase upon completion of the casting start phase, characterized in that, during the steady-state casting phase, a second cooling water characterized by a second composition, different from the first cooling water, is used. Optionally, this second cooling water is obtained according to the preparation method. Optionally, this second composition is a second mixture composition obtained according to the preparation method. According to another embodiment, the second cooling water is not obtained according to the preparation method of the invention, it may be an industrial water solution.

Finally, the aim of the invention may also be achieved thanks to the implementation of a casting device comprising a device for preparing a cooling water, said preparation device comprising a mixing unit configured to receive a first aqueous solution characterized by a first composition and a second aqueous solution distinct from the first aqueous solution and characterized by a second composition, said first aqueous solution and said second aqueous solution being selected from the group composed of:
an industrial water solution,
a cationic ion exchange resin-treated water solution,
a demineralized water solution,
an aqueous solution containing Mg²⁺ and Ca²⁺ ions,

said mixing unit being further configured to mix a first volume of said first aqueous solution and a second volume of said second aqueous solution, so as to make a mixing volume of a mixture solution characterized by a mixture composition and forming all or part of the cooling water, said first volume of the first aqueous solution and second volume of the second aqueous solution being determined according to said first composition and said second composition, and so that the mixture composition tends towards a predetermined target final composition.

The casting device may further have one or more of the following features, considered separately or in combination.

According to one embodiment, the mixing unit is configured to mix a number of volumes of aqueous solutions greater than or equal to two.

According to one embodiment, the preparation device comprises at least one tank selected from among:
a first tank configured to receive the industrial water solution;
a second tank configured to receive the cationic ion exchange resin-treated water solution;
a third tank configured to receive the demineralized water solution;
a fourth tank configured to receive the aqueous solution containing Mg²⁺ and Ca²⁺ ions.

According to one embodiment, the use of the first tank, the second tank, the third tank, and the fourth tank may be replaced by an on-line continuous mixing method. By “on-line continuous mixing method”, it should be understood the possibility of making the mixtures of the aqueous solutions directly in a supply piping system or by inserting a static mixer or a low-volume mixing reactor.

According to one embodiment, the mixing unit is further configured to receive at least one additive element selected from the group comprising salts and pH correctors, and to mix an additive element mass with the mixture solution, said additive element mass being determined according to the first composition, the second composition, and the target final composition.

According to one embodiment, the preparation device further comprises an additive element storage unit configured to store said at least one additive element.

According to one embodiment, the casting device further comprises a calculation unit configured to determine the first volume of the first aqueous solution and the second volume of the second aqueous solution according to a useful parameter defining the first composition, a useful parameter defining the second composition, and so that a useful parameter defining the mixture composition tends towards a useful parameter defining the target final composition. According to one embodiment, the casting device further comprises a cation exchanger comprising an active material, said cation exchanger being configured to vary between a charged configuration in which calcium Ca²⁺ or magnesium Mg²⁺ divalent cations are bonded to the active material, and a regenerated configuration in which the active material is able to capture calcium Ca²⁺ or magnesium Mg²⁺ divalent cations, said cation exchanger comprising means allowing connecting it to the mixing unit. According to one embodiment, the cation exchanger comprises a weak cationic ion exchange resin. According to one embodiment, the cation exchanger comprises a strong cationic ion exchange resin.

According to one embodiment, the cation exchanger comprises means allowing connecting it to at least one tank, for example the first tank, the second tank, the third tank, or the fourth tank.

According to one embodiment, the casting device further comprises a reverse osmosis unit or a demineralization resin ion exchanger, said reverse osmosis unit or said ion exchanger comprising means allowing connecting it to the mixing unit and to the cation exchanger.

According to one embodiment, said reverse osmosis unit or said demineralization resin ion exchanger comprises means allowing connecting it to at least one tank, for example the first tank, the second tank, the third tank, or the fourth tank.

According to one embodiment, the preparation device comprises a strong acid supply, said strong acid supply being configured to be connected to the cation exchanger.

According to one embodiment, the casting device further comprises an analysis unit configured to measure at least one useful parameter selected from the group comprising: a calcium concentration, a magnesium concentration, a M-alkalinity, a P-alkalinity, a Hardness, and the pH.

According to one embodiment, the mixing unit comprises a temperature control system comprising a temperature sensor configured to measure a mixing temperature corresponding to the temperature of the mixture solution, said temperature control system being configured to maintain the mixing temperature between 10° C. and 35° C. preferably between 12° C. and 30° C.

According to one embodiment, the temperature control system comprises heating means configured to heat the mixing unit, when the mixing temperature is lower than or equal to 10° C., preferably lower than 12° C.

According to one embodiment, the temperature control system comprises cooling means configured to cool the mixing unit, when the mixing temperature is higher than or equal to 35° C., preferably 30° C.

### DESCRIPTION OF THE FIGURES

Other aspects, aims, advantages and features of the invention will appear better upon reading the following detailed description of preferred embodiments thereof, given as a non-limiting example, and made with reference to the appended drawings, wherein:

FIG. 1 is a schematic view of the casting device comprising a preparation device according to a particular embodiment of the invention.

FIG. 2 is a schematic view of some elements of the casting device allowing preparing aqueous solutions, according to a particular embodiment of the invention.

FIG. 3 is a schematic view of the steps of the preparation method according to a particular embodiment of the invention.

### DETAILED DESCRIPTION

In the figures and in the remainder of the description, the same references represent identical or similar elements. In addition, the various elements are not plotted to scale so as to favor clarity of the figures. Moreover, the different embodiments and variants are not exclusive of one another and could be combined together.

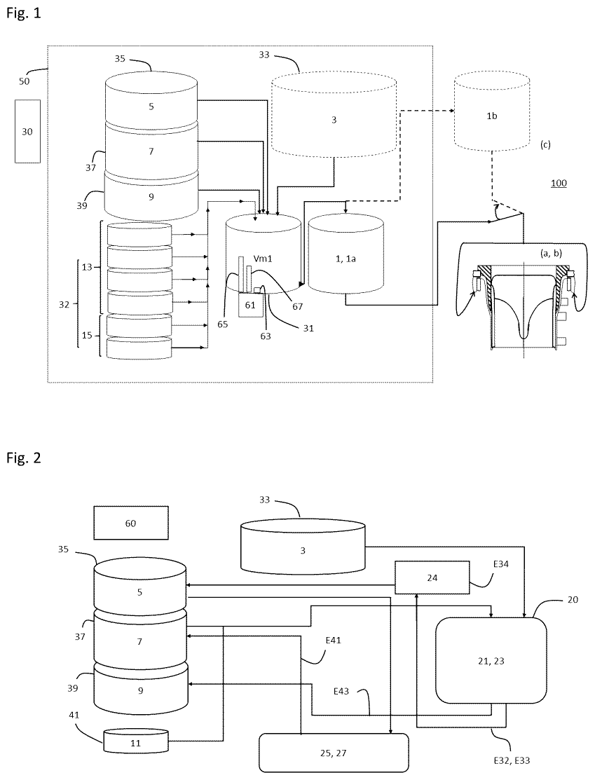

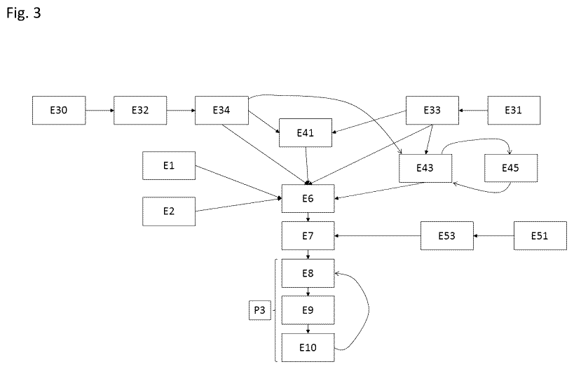

As illustrated in FIGS. 1 to 3, the present invention relates to a method for preparing a cooling water 1 intended to cool a product during a metallurgical transformation operation and in particular for cast part applications. The invention also relates to the use of a cooling water 1 obtained according to this preparation method, to cool a product in a metallurgical transformation step, such as casting, quenching, or hot rolling.

Unlike continuous casting, where the concept of start step is not paramount with regards the quality of the final product because it is possible to avoid the portion of the product with defects, it is important to control cooling during the start phase of a product obtained by semi-continuous casting otherwise it would not be possible to manufacture it. In semi-continuous casting, the difficulty lies in the success of the passage from the zero speed at the beginning of formation of the product to the steady-state speed. We talk about start phase. This passage is reflected by a deformation of the plate foot, known to a person skilled in the art as camber. If it is too pronounced, which happens when the foot is cooled too abruptly, the camber could result in what a person skilled in the art calls “sink marks”, which may sometimes degenerate into “warping”, i.e. a jamming of the plate in its mold. The camber associated with an unsuitable cooling regime may result, in a less catastrophic manner, in a break-up of the foot or in slits in the foot. These break-ups or slits are completely harmful because they could propagate in the steady-state mode therefore resulting in discarding the product, otherwise and at least, they prevent hot rolling of the plate without sawing the foot to restore the integrity of the product. Finally, a camber that causes no scrap still features variations in the section of the product which might prevent rolling of the products without sawing the foot.

A person skilled in the art knows how to implement casting conditions suitable for minimizing the apparition of these defects. Nonetheless, it is important for the found conditions to be reproducible from one casting to another. In particular, the Inventors have found that it was important to have cooling water that is reproducible throughout the start phases in order to guarantee the same thermal efficiency. The Inventors have solved this problem by proposing a method for preparing a cooling water allowing making a target cooling water on demand.

For example, the target cooling water may correspond to an industrial water available at a site on which the casting process will be implemented on a large scale, this site being different from the production site considered for the implementation of the preparation of the cooling water. For example, the target cooling water may correspond to industrial water available for a given period of the year. This is the case, for example, when the industrial water of a site is drawn in a river and when, according to the summer/winter seasonality, its composition evolves. It might be interesting to choose to always have identical industrial water irrespective of the season. The target cooling water may be a water considered to be suitable for starting casting by its energy efficiency quality.

FIG. 1 shows a method for casting a product, preferably made of an aluminum alloy, which comprises the following steps:
(a) preparing a liquid metal bath, preferably made of aluminum alloy comprising, in % by weight, Cu: 0-6.0; Mg: 0-8; Si 0-12; Zn 0-12; others ≤3 each and ≤10 in total, the remainder aluminum, and
(b) casting said liquid metal, preferably by vertical semi-continuous casting, such that, during a solidification start phase, a first cooling water 1a characterized by a first mixture composition cma obtained according to the preparation method according to the invention which will be described in more details hereinafter is used.

Preferably, an aluminum alloy of the AA1xxx or AA2xxx or AA3xxx or AA4xxx or AA5xxx or AA6xxx or AA7xxx series is cast.

As non-limiting examples, examples of aluminum alloys of the AA1xxx series to be used in the methods described herein may include AA1100, AA1100A, AA1200, AA1200A, AA1300, AA1110, AA1120, AA1230, AA1230A, AA1235, AA1435, AA1145, AA1345, AA1445, AA1150, AA1350, AA1350A, AA1450, AA1370, AA1275, AA1185, AA1285, AA1385, AA1188, AA1190, AA1290, AA1193, AA1198 or AA1199.

Non-limiting examples of aluminum alloys of the AA2xxx series to be used in the methods described herein may include AA2001, A2002, AA2004, AA2005, AA2006, AA2007, AA2007A, AA2007B, AA2008, AA2009, AA2010, AA2011, AA2011A, AA2111, AA2111A, AA2111B, AA2012, AA2013, AA2014, AA2014A, AA2214, AA2015, AA2016, AA2017, AA2017A, AA2117, AA2018, AA2218, AA2618, AA2618A, AA2219, AA2319, AA2419, 2022, AA, AA24,20 AA2124, AA2224, AA2224A, AA2324, AA2424, AA2524, AA2624, AA2724, AA2824, AA2025, AA2026, AA2027, AA2028, AA2028A, AA2028B, AA2028C, AA2029, AA2030, AA2031, AA2032, AA2034, AA2036, AA2037, AA2038, AA2039, AA2139, AA2040, AA2041, AA2044, AA2045, AA2050, AA2055, AA2056, AA2060, AA2065, AA2070, AA2076, AA2090, AA2091, AA2094, AA2095, AA2195, AA2295, AA2196, AA2296, AA2097, AA2197, AA2297, AA2397, AA2098, AA2198, AA2099, or AA2199.

Non-limiting examples of aluminum alloys of the AA3xxx series to be used in the methods described herein may include AA3002, AA3102, AA3003, AA3103, AA3103A, AA3103B, AA3203, AA3403, AA3004, AA3004A, AA3104, AA3204, AA3304, AA3005, AA3005A, AA3105A, AA3105B, AA3007, AA3107, AA3207, AA3207A, AA3307, AA3009, AA3010, AA3110, AA3011, AA3012, AA3012A, AA3013, AA3014, AA3015, AA3016, AA30, 26, AA30, AA30, AA30 or AA3065.

Non-limiting examples of aluminum alloys of the AA4xxx series to be used in the methods described herein may include AA4004, AA4104, AA4006, AA4007, AA4008, AA4009, AA4010, AA4013, AA4014, AA4015, AA4015A, AA4115, AA4016, AA4017, AA AA4019, AA4020, AA4021, AA4026, AA4032, AA4043, AA4043A, AA4143, AA4343, AA4643, AA4943, AA4044, AA4045, AA4145, AA4145A, AA4046, AA4047, AA4047A, or AA44.

Non-limiting examples of aluminum alloys of the AA5xxx series to be used in the methods described herein may include AA5182, AA5183, AA5005, AA5005A, AA5205, AA5305, AA5505, AA5605, AA5006, AA5106, AA5010, AA5110, AA5110A, AA5210, AA5310, AA5016, AA5017, AA5018, AA5018A, AA5019, AA5019A, AA5119, AA5119A, AA5021, AA5022, AA5023, AA5024, AA5026, AA5027, AA5028, AA5040, AA5140, AA5041, AA5042, AA5043, AA5049, AA5149, AA5249, AA5349, AA5449, AA5449A, AA5050, AA5050A, AA5050C, AA5150, AA5051, AA5051A, AA5151, AA5251, AA5251A, AA5351, AA5451, AA5052, AA5252, AA5352, AA5154, AA5154A, AA5154B, AA5154C, AA5254, AA5354, AA5454, AA5554, AA5654, AA5654A, AA5754, AA5854, AA5954, AA5056, AA5356, AA5356A, AA5456, AA5456A, AA5456B, AA5556, AA5556A, AA5556B, AA5556C, AA5257, AA5457, AA5557, AA5657, AA5058, AA5059, AA5070, AA5180, AA5180A, AA5082, AA5182, AA5083, AA5183, AA5183A, AA5283, AA5283A, AA5283B, AA5383, AA5483, AA5086, AA5186, AA5087, AA5187, or AA5088.

Non-limiting examples of aluminum alloys of the AA6xxx series to be used in the methods described herein may include AA6101, AA6101 A, AA6101B, AA6201, AA6201A, AA6401, AA6501, AA6002, AA6003, AA6103, AA6005, AA6005A, AA6005B, AA6005C, AA6105, AA6205, AA6305, AA6006, AA6106, AA6206, AA6306, AA6008, AA6009, AA6010, AA6110, AA6110A, AA6011, AA6111, AA6012, AA6012A, AA6013, AA6113, AA6014, AA6015, AA6016, AA6016A, AA6116, AA6018, AA6019, AA6020, AA6021, AA6022, AA6023, AA6024, AA6025, AA6026, AA6027, AA6028, AA6031, AA6032, AA6033, AA6040, AA6041, AA6042, AA6043, AA6151, AA6351, AA6351A, AA6451, AA6951, AA6053, AA6055, AA6056, AA6156, AA6060, AA6160, AA6260, AA6360, AA6460, AA6460B, AA6560, AA6660, AA6061, AA6061A, AA6261, AA6361, AA6162, AA6262, AA6262A, AA6063, AA6063A, AA6463, AA6463A, AA6763, AA6963, AA6064, AA6064A, AA6065, AA6066, AA6068, AA6069, AA6070, AA6081, AA6181, AA6181A, AA6082, AA6082A, AA6182, AA6091, or AA6092.

Non-limiting examples of aluminum alloys of the AA7xxx series to be used in the methods described herein may include AA7011, AA7019, AA7020, AA7021, AA7039, AA7072, AA7075, AA7085, AA7108, AA7108A, AA7015, AA7017, AA7018, AA7019A, AA7024, AA7025, AA7028, AA7030, AA7031, AA7033, AA7035, AA7035A, AA7046, AA7046A, AA7003, AA7004, AA7005, AA7009, AA7010, AA7011, AA7012, AA7014, AA7016, AA7116, AA7122, AA7023, AA7026, AA7029, AA7129, AA7229, AA7032, AA7033, AA7034, AA7036, AA7136, AA7037, AA7040, AA7140, AA7041, AA7049, AA7049A, AA7149, 7204, AA7249, AA7349, AA7449, AA7050, AA7050A, AA7150, AA7250, AA7055, AA7155, AA7255, AA7056, AA7060, AA7064, AA7065, AA7068, AA7168, AA7175, AA7475, AA7076, AA7178, AA7278, AA7278A, AA7081, AA7181, AA7185, AA7090, AA7093, AA7095, or AA7099.

As illustrated in the non-limiting example of FIG. 1, the casting method may comprise a steady-state phase c upon completion of the casting start phase characterized in that during the casting steady-state phase c, a second cooling water is used. The second cooling water 1b is characterized by a second target final composition cfb. For example, this second cooling water 1b may also be obtained according to the preparation method which will be described in more details hereinafter. Alternatively, the second cooling water 1b may correspond to an industrial water solution 3.

FIGS. 1 to 3 show a non-limiting example of a preparation method according to a particular embodiment of the invention.

The preparation method comprises a first step E1 of analyzing the composition of a target cooling water 1. This analysis step allows determining a target final composition cfc. In general, according to the invention, determining a composition corresponds to determining at least one useful parameter selected from the group comprising a calcium concentration THCa, a magnesium concentration THMg, a M-alkalinity TAC, a P-alkalinity TA, a Hardness TH, a concentration of chlorides CCI, sulfates CS, bromides CBr, sodium CNa ions, and a pH.

Thus, the target final composition cfc, determined by the first analysis step E1 allows defining at least one target useful parameter puc selected from the group comprising a calcium concentration THCa, a magnesium concentration THMg, a M-alkalinity TAC, a P-alkalinity TA, a Hardness TH, a concentration of chlorides CCI, sulfates CS, bromides CBr, sodium CNa ions, and a pH.

The preparation method also comprises a step E6 of providing at least one first aqueous solution characterized by a first composition c1 and at least one second aqueous solution distinct from the first aqueous solution and characterized by a second composition c2, said first aqueous solution and said second aqueous solution being selected from the group composed of:
an industrial water solution 3,
a cationic ion exchange resin-treated water solution 5,
a demineralized water solution 7,
an aqueous solution containing Mg²⁺ and Ca²⁺ ions 9.

In the same manner as for the target final composition cfc, the first composition c1 and the second composition c2 are defined by at least one useful parameter pu1 and pu2 selected from the group comprising a calcium concentration THCa, a magnesium concentration THMg, a M-alkalinity TAC, a P-alkalinity TA, a Hardness TH, a concentration of chlorides CCI, sulfates CS, bromides CBr, sodium CNa ions, and a pH. Said defined at least one useful parameter pu1 and pu2 are of the same nature as said at least one target useful parameter puc. The compositions c1 and c2 are different.

Preferably, the industrial water solution 3 is characterized by a conductivity comprised between 100 μS/cm and 2,000 μS/cm.

Preferably, the cationic ion exchange resin-treated water solution 5 is a decarbonated water, preferably a decarbonated water with a conductivity higher than or equal to 100 μS/cm and a Hardness TH in French degree (° f) and a M-alkalinity TAC in French degree (° f) such that TH≤TAC+3° f. Preferably, the cationic ion exchange resin-treated water solution 5 is a permuted water, preferably a permuted water with a conductivity higher than or equal to 100 μS/cm and a Hardness TH in French degree (° f) such that TH≤3° f.

Preferably, the demineralized water 7 has a conductivity lower than 100 μS/cm.

Preferably, the aqueous solution containing Mg²⁺ and Ca²⁺ ions has a conductivity higher than or equal to 20 μS/cm and a Hardness TH in French degree (° f) such that TH≥50° f.

According to the invention, in one embodiment, both the first aqueous solution and the second aqueous solution may consist of an industrial water solution or a cationic ion exchange resin-treated water solution or an aqueous solution containing Mg²⁺ and Ca²⁺ ions, the compositions c1 and c2 being, nonetheless, different.

More particularly, FIG. 2 illustrates different means for obtaining the aforementioned four solutions.

For example, the industrial water solution 3 corresponds to a water present on an industrial site on which the preparation method object of the invention is implemented. This industrial site could a site distinct from the industrial site on which the target cooling water is available. For example, the target cooling water may correspond to industrial water available on a site on which the casting process will be implemented on a large scale. In turn, the industrial water solution 3 may correspond to an industrial water present on an industrial site for developing the casting process. The industrial water solution 3 may also be derived from pumping in the groundwater, then treated by different steps such as a deferrization, and/or a filtration, and/or a red-ox stabilization, in order to be stable and usable for the industrial needs of the site. The industrial water solution 3 may also originate from a basin enabling water recycling by cooling (for example using a cooling tower or a cold generation unit). Thus, it could therefore be advantageous for the preparation method to comprise a second analysis step E2 in which at least one useful parameter of said industrial water solution 3 selected from the group comprising a calcium concentration THCa, a magnesium concentration THMg, a M-alkalinity TAC, a P-alkalinity TA, a Hardness TH, a concentration of chlorides CCI, sulfates CS, bromides CBr, sodium CNa ions, and a pH is measured. The useful parameter analyzed in the analysis step E2 is of the same nature as the at least one target useful parameter puc. By “of the same nature”, it should be understood that if the Hardness TH is selected to define the target final composition cfc, the Hardness TH of the industrial water 3 is determined. Such a second analysis step E2 may also be implemented to determine at least one useful parameter of the cationic ion exchange resin-treated water solution 5, and/or to determine at least one useful parameter of the demineralized water solution 7, and/or to determine at least one useful parameter of the aqueous solution containing Mg²⁺ and Ca²⁺ ions 9. Thus, it is possible to select the aqueous solution(s) having the most suitable composition to serve as a basis for making a mixture solution having a mixture composition cm1 which tends towards the target final composition cfc.

Next, in the description, when reference is made to “aqueous solutions”, it should be understood the group composed of the industrial water solution 3, the cationic ion exchange resin-treated water solution 5, the demineralized water solution 7, and the aqueous solution containing Mg²⁺ and Ca²⁺ ions 9.

The cationic ion exchange resin-treated water solution 5 may be obtained according to two methods described hereinafter.

According to a first non-limiting variant, the cationic ion exchange resin-treated water solution is a decarbonated water obtained according to the following steps:
a step E30 of providing a cation exchanger 20 comprising a weak cationic ion exchange resin 21, said cation exchanger 20 being configured to vary between a regenerated configuration in which said weak cationic ion exchange resin 21 is able to capture calcium Ca²⁺ or magnesium Mg²⁺ divalent cations and a charged configuration in which said weak cationic ion exchange resin 21 forms a reserve of calcium Ca²⁺ or magnesium Mg²⁺ divalent cations;
a weak cationic ion exchange resin absorption step E32 in which a portion of the industrial water solution 3 flows in the cation exchanger 20 to make it vary from the regenerated configuration into the charged configuration;
a degassing step E34 in which a water coming out of the cation exchange 20 is degassed, so as to obtain the decarbonated water.

For example, the degassing step E34 may be implemented naturally, by leaving the water coming out of the cation exchanger 20 in the open air. Alternatively, the degassing step E34 may be implemented in a degassing column 24. According to a third possibility, the degassing step E34 may be implemented by subjecting the water coming out of the cation exchanger 20 to successive cascades, or by blending, stirring, bubbling, or by the use of a streaming degassing column 24 in which counter-flow air is injected.

Preferably, the decarbonated water has a conductivity higher than or equal to 100 μS/cm and a Hardness TH in French degree (° f) and a M-alkalinity CAT in French degree (° f) such as TH≤TAC+3° f.

According to a second non-limiting variant, the cationic ion exchange resin-treated water solution 5 is a permuted water obtained according to the following steps:
a step E31 of providing a cation exchanger 20 comprising a strong cationic ion exchange resin 23, said cation exchanger 20 being configured to vary between a regenerated configuration in which said strong cationic ion exchange resin 23 is able to capture calcium Ca²⁺ or magnesium Mg²⁺ divalent cations and a charged configuration in which said strong cationic ion exchange resin 23 forms a reserve of calcium Ca²⁺ or magnesium Mg²⁺ divalent cations;
a strong cationic ion exchange resin absorption step E33 in which a portion of the industrial water solution 3 flows in the cation exchanger 20 to make it vary from the regenerated configuration into the charged configuration, and so as to obtain the permuted water.

According to one embodiment, the step E32, E33 comprises a step of detecting the charge level, in which a measurement of the variation of the pH or of another parameter of the water present at the outlet of the cation exchanger 20 is carried out, so as to deduce therefrom (for example for future cycles) the charge level of the cation exchanger 20 at all times.

Preferably, the permuted water with a conductivity higher than or equal to 100 μS/cm and a Hardness TH in French degree (° f) such that TH≤3° f.

In the case where the industrial water solution 3 is not very calcareous, it is advantageous to obtain the cationic ion exchange resin-treated water solution 5 by a cation exchanger 20 using a strong cationic ion exchange resin active material 23.

The demineralized water solution may be obtained by any method known from the prior art. According to the principle of the invention, in a preferred embodiment, the demineralized water solution 7, may be obtained by a demineralization step E41 in which a portion of the decarbonated water or permuted water solution is demineralized by a process of reverse osmosis 27 or ion exchange on a series of demineralization resins (cationic/anionic) 25 so as to obtain the demineralized water solution 7.

According to one embodiment, the demineralized water solution 7 may be obtained by a charging step E33 so as to permute the cations by Hydronium ions H3O+ on the strong cationic ion exchange resin, followed by a step E41 of demineralization on resins 25 in which a portion of the water whose cations are already permuted by H3O+ will be treated simply on a series of anionic resins 25. A prior degassing may be performed before passage over anionic resins 25. Preferably, the demineralized water 7 has a conductivity lower than 100 μS/cm.

Finally, the aqueous solution containing Mg²⁺ and Ca²⁺ ions 9 is obtained during an elution step E43 in which a strong acid 11 is circulated in the cation exchanger 20, so that Mg²⁺ and Ca²⁺ ions captured by the weak cationic ion exchange resin 21 or by the strong cationic ion exchange resin 23 are dissolved, so as to make the aqueous solution containing Mg²⁺ and Ca²⁺ ions 9. In general, the strong acid 11 is hydrochloric acid or sulfuric acid diluted preferably at a concentration between 2 and 10% in water. In the particular case where the strong acid 11 is a sulfuric acid, the aqueous solution containing Mg²⁺ and Ca²⁺ ions 9 obtained in the elution step E43 also contains dissolved salts of MgSO₄ and MgSO₄. These salts are particularly interesting to obtain because they avoid the use of additive elements containing sulfur. Indeed, this aqueous solution containing Mg²⁺ and Ca²⁺ ions 9 contains MgSO₄ and MgSO₄ salts is obtained directly from the industrial water and an acid. This avoids, on the one hand, supplying salts such as calcium sulfate (CaSO4) or magnesium sulfate (MgSO₄). On the other hand, it is known in particular that calcium sulfate, commonly known as “plaster”, in common language, has a very low solubility in water and dissolving it is complex and difficult.

Advantageously, the elution step E43 is implemented after the charging step E32, E33. Hence, it should be understood that the elution E43, and charging E32, E33, steps allow making the cation exchanger 20 vary alternately between the regenerated configuration and the charged configuration.

According to one embodiment, the elution step E43 may comprise a measurement step E45 in which a pH of the aqueous solution containing Mg²⁺ and Ca²⁺ ions 9 is measured. Indeed, the elution step E 43 being implemented by the circulation of a strong acid in the cation exchanger 20, it is possible to find traces of strong acid 11 in the aqueous solution containing Mg²⁺ and Ca²⁺ ions 9, which could contribute to lowering its pH. In order to better control the composition of the aqueous solution containing Mg²⁺ and Ca²⁺ ions 9, it is therefore preferable to guarantee the absence of the strong acid 11 in this solution. To avoid this, it is possible to provide for an amount of strong acid 11 added during the elution step E43 being defined relative to a volume of weak 21 or strong 23 cationic ion exchange resin to be treated. For example, such an amount of strong acid 11 may form part of the technical data of the used cationic ion exchange resin 21, 23, said data specifying the volume and the concentration of strong acid 11 necessary to regenerate said cationic ion exchange resin 21, 23. In this manner, it is possible to prevent mixing of the strong acid 11 with the aqueous solution containing Mg²⁺ and Ca²⁺ ions 9 when the weak 21 or strong 23 cationic ion exchange resin is totally regenerated. Alternatively, the measurement step E45 may be implemented by measuring a parameter other than the pH, like for example measuring the conductivity. In this manner, it is possible to know and control a possible excess of strong acid 11 during the elution step E43.

Preferably, the aqueous solution containing Mg²⁺ and Ca²⁺ ions has a conductivity higher than or equal to 20 μS/cm and a Hardness TH in French degree (° f) such that TH≥50° f.

Referring to FIG. 1, the preparation method may further comprise a step E51 of providing at least one additive element selected from the group comprising salts 13 and pH correctors 15. In particular, the salts 13 and pH correctors 15 may comprise: sodium chloride NaCl, sodium bicarbonate NaHCO₃, sodium carbonate Na₂CO₃, calcium chloride CaCl₂, magnesium sulfate MgSO₄, magnesium chloride MgCl₂, and sodium bromide NaBr. Afterwards, a mass denoted “m” of additive elements may be diluted in an aqueous solution during a dilution step E 53 to form an additive solution. For example, the mass m of additive element may be diluted in a portion of the demineralized water solution 7. In the case where several addition elements are added, it is possible to make several additive solutions each corresponding to a diluted additive element. In this case, several masses mj corresponding to each additive element j are diluted in an aqueous solution.

Referring again to the supply step E6, it should be understood that this step E6 of providing the first aqueous solution and the second aqueous solution is not restrictive and that it may also comprise providing a number of volumes of distinct aqueous solutions greater than two. Thus, the supply step E6 may comprise providing a third or a fourth aqueous solution selected so as to be distinct from one another and distinct from the first aqueous solution and the second aqueous solution, said third or fourth aqueous solution being selected from the group composed of:
the industrial water solution 3,
the cationic ion exchange resin-treated water solution 5,
the demineralized water solution 7,
the aqueous solution containing Mg²⁺ and Ca²⁺ ions 9.

Afterwards, the preparation method may comprise a calculation step E7 in which a first volume V1 of the first aqueous solution and a second volume V2 of the second aqueous solution are determined according to said at least one useful parameter pu1 defining the first composition c1, and said at least one useful parameter pu2 defining the second composition c2. In the case where salts 13 and pH correctors 15 are made available during step E51, the calculation step E7 is also intended to determine the mass m of additive element according to the first composition c1, the second composition c2, and the target final composition cfc. As indicated before, the determination of a first volume V1 of a first aqueous solution, and of a second volume V2 of a second aqueous solution is not limiting, and the calculation step E7 may also comprise determining a third volume V3 of a third aqueous solution characterized by a third composition c3, and a fourth volume V4 of a fourth aqueous solution characterized by a fourth composition c4.

These volumes V1, V2, V3 and V4 of aqueous solutions, and this mass m are intended to be mixed during a mixing phase P3 which will be described later on, and so as to make a mixing volume Vm1 of a mixture solution characterized by a mixture composition cm1 which may also be defined by at least one useful parameter pumi selected from the group comprising a calcium concentration THCa, a magnesium concentration THMg, a M-alkalinity TAC, a P-alkalinity TA, a Hardness TH, a concentration of chlorides CCI, sulfates CS, bromides CBr, sodium CNa ions, and a pH.

Hence, the calculation step E7 is intended to determine the volumes of aqueous solutions V1, V2, V3 and V4 and the mass m so that said at least one useful parameter pumi defining the mixture composition cm1 tends towards at least one useful parameter puc defining the target final composition cfc. Hence, it should be understood that, depending on the calculation step, the volumes V1, V2, V3 or V4 may be zero and that the mass m may be zero.

For example, according to a first non-limiting variant, the calculation step E7 allows determining the first volume V1 of the first aqueous solution determined by at least one first useful parameter pu1 of the same nature as the at least one target useful parameter puc and the second volume V 2 of the second aqueous solution determined by at least one second useful parameter pu2 of the same nature as the at least one target useful parameter puc. The calculation step may consist in solving the following system of equations:

$$pu 1 * V 1 + pu 2 * V 2 = puc * Vm 1$$

$$Vm 1 = V 1 + V 2$$

In the case where several useful target parameters are determined for the target final composition cfc, the described calculation method consists in solving as many systems of equations as determined target useful parameters.

In this case, it is advantageous to use a calculation unit 30.

According to one embodiment, the calculation step E7 is implemented by a calculation unit 30 configured to calculate the first volume V1 of the first aqueous solution and the second volume V2 of the second aqueous solution so as to minimize a difference between said at least one useful parameter defining the mixture composition cm1 and said at least one useful parameter defining the target final composition cfc. In the case where the target final composition cfc is defined by several parameters, there are sometimes no solutions for V1 and V2 allowing solving the system. Advantageously, the calculation unit 30 allows making priority choices on the accuracy of one of the useful parameters relative to others. In this manner, it is possible to implement the preparation method in the case where there is no unique or exact mathematical solution for the preparation of the cooling water 1 having a composition close to the final composition cfc.

According to one embodiment, each of the first composition c1, the second composition c2, the mixture composition cm1, and the target final composition cfc, is defined by a plurality of useful parameters, the calculation step E7 may then be implemented by weighting each useful parameter of said plurality of useful parameters by a weighting coefficient.

According to one embodiment, the calculation step E7 may be implemented by comparing each useful parameter with another useful parameter of the same type. For example, according to another non-limiting variant, the calculation step E7 allows determining the first volume V1 of the first aqueous solution and the second volume V2 of the second aqueous solution by comparing the M-alkalinity TAC of the first aqueous solution, the M-alkalinity TAC of the second aqueous solution, and the M-alkalinity TAC of the cooling water 1. Thus, each useful parameter may be compared with another useful parameter of the same type during the calculation step E7.

Finally, the preparation method comprises, the mixing phase P3 comprising a first mixing step E8 in which the first volume V1 of the first aqueous solution and the second volume V2 of the second aqueous solution are mixed, so as to make the mixing volume Vm1 of a mixture solution characterized by a mixture composition cm1. This mixture solution then forms all or part of the cooling water 1.

It should be understood that said first volume V1 of the first aqueous solution and second volume V2 of the second aqueous solution are determined during the calculation step E7, according to said first composition c1 and said second composition c2, and so that the mixture composition cm1 tends towards the predetermined target final composition cfc.

Like during the supply step E6, the mixing phase P3 is not limited to the first volume V1 of the first aqueous solution and to the second volume V2 of the second aqueous solution and may also comprise the mixture of a number of distinct volumes of aqueous solutions greater than two. For example, the supply step E6 may comprise mixing the third and/or the fourth aqueous solution with the first and second aqueous solutions. Moreover, the first mixing step E8 may also comprise mixing the mass m of additive element, itself also determined during the calculation step E7. Thus, and according to a particular embodiment, the cooling water 1 may be obtained by mixing four volumes V1, V2, V3, V4 of aqueous solutions, each volume of aqueous solution originating respectively from the industrial water solution 3, from the cationic ion exchange resin-treated water solution 5, from the demineralized water solution 7, and from the aqueous solution containing Mg²⁺ and Ca²⁺ ions 9, and the mass m of additive element.

Afterwards, the mixing phase P3 may comprise a step E9 of controlling the mixture composition cm1, in which an intermediate value of said at least one useful parameter defining the mixture composition cm1 is determined, so as to calculate an initial deviation between said intermediate value and a target value of said at least one useful parameter defining the target final composition cfc. Hence, the control step E9 allows determining the deviation between the useful parameters of the mixture composition cm1 and the corresponding useful parameters of the target final composition cfc. In other words, the control step E9 allows quantifying whether the mixture composition cm1 is sufficiently close to the target final composition cfc.

In the case where the initial deviation is higher than a threshold deviation, i.e. when the mixture composition cm1 is too far from the target final composition cfc, the mixing phase may comprise a second mixing step E10 in which at least one correction element is mixed with the mixture solution so as to make a corrected mixing volume Vm2 of a corrected mixture solution characterized by a corrected mixture composition cm2 which is defined by at least one useful parameter. This correction element is selected from the group composed of: a volume of the industrial water solution 3, a volume of the cationic ion exchange resin-treated water solution 5, a volume of the demineralized water solution 7, a volume of the aqueous solution containing Mg²⁺ and Ca²⁺ ions 9, a mass m1 of salt 13, and a mass m2 of pH correctors 15.

Naturally, the correction element is selected so that a corrected deviation between a corrected value of said at least one useful parameter defining the corrected mixture composition cm2 and said target value is lower than the initial deviation.

According to one embodiment, it may be provided for the control step E9 comprising determining the corrected deviation, and for the second mixing step E10 being implemented iteratively as long as the corrected deviation is greater than the deviation threshold. For example, the threshold deviation may be equal to 10% or 5% or 3% of the target value.

In general, it may also be provided for at least one mixing step among the first mixing step E8 and the second mixing step E10 being implemented so as to maintain the corrected mixing solution at a temperature comprised between 10° C. and 35° C., preferably between 12° C. and 30° C.

The previously-described arrangements allow proposing a method for preparing a cooling water 1 having a composition close to a target final composition cfc. Moreover, and advantageously, the use of the aqueous solution containing Mg²⁺ and Ca²⁺ ions 9 allows producing more easily and on demand, a cooling water 1 having a composition close to the target final composition cfc.

According to the invention, the aqueous solution containing Mg²⁺ and Ca²⁺ ions is such that the concentration of Mg²⁺ and Ca²⁺ ions is higher than the concentration of Mg²⁺ and Ca²⁺ ions of the industrial water solution, the cationic ion exchange resin-treated water solution, or the demineralized water solution.

As indicated before, the preparation method, and the casting method may be implemented by means of a casting device 100, object of the invention.

The casting device, shown in FIG. 1, comprises a device 50 for preparing a cooling water 1. In particular, the preparation device 50 may comprise at least one tank selected from among:
a first tank 33 configured to receive the industrial water solution 3;
a second tank 35 configured to receive the cationic ion exchange resin-treated water solution 5;
a third tank 37 configured to receive the demineralized water solution 7;
a fourth tank 39 configured to receive the aqueous solution containing Mg²⁺ and Ca²⁺ ions 9.

The embodiment of FIG. 1 features a preparation device 50 comprising four tanks.

According to an embodiment that is not shown, the use of the first tank 33, the second tank 35, the third tank 37, and the fourth tank 39 may be replaced by an on-line continuous mixing process. By “on-line continuous mixing method”, it should be understood the possibility of making the mixtures of the aqueous solutions directly in a piping or supply system.

The casting device 100 may further comprise a cation exchanger 20 (FIG. 2) comprising an active material, said cation exchanger 20 being configured to vary between a charged configuration in which calcium Ca²⁺ or magnesium Mg²⁺ divalent cations are bonded to the active material, and a regenerated configuration in which the active material is able to capture calcium Ca²⁺ or magnesium Mg²⁺ divalent cations, said cation exchanger 20 comprising means allowing connecting it to the mixing unit 31, not shown. The active material may comprise either a weak cationic ion exchange resin 21 or a strong cationic ion exchange resin 23. As illustrated in FIG. 2, the cation exchanger 20 is included in the preparation device 50. In order to be able to simply implement the preparation method, the cation exchanger 20 may comprise means allowing connecting it to at least one tank, for example the first tank 33, the second tank 35, the third tank 37, or the fourth tank 39. For example, these means may comprise pipes allowing performing a fluid transfer towards and out of the cation exchanger 20.

The casting device 100 may also comprise a reverse osmosis unit 27 or a demineralization resin ion exchanger 25, said reverse osmosis unit 27 or said ion exchanger comprising means for connecting it to a mixing unit 31 and to the cation exchanger 20, not shown. In general, the reverse osmosis unit 27 or said demineralization resin ion exchanger 25 comprises means allowing connecting it to at least one tank, for example the first tank 33, the second tank 35, the third tank 37, or the fourth tank 39. In the variant illustrated in FIG. 2, the reverse osmosis unit 27 comprises means allowing fluidly connecting it to the second tank 35, and to the third tank 37.

The preparation device 50 may comprise a strong acid supply 41 configured to be connected to the cation exchanger 20, and an additive element storage unit 32 configured to store at least one additive element selected from the group comprising salts 13 and pH correctors 15.

Referring again to FIG. 1, the first tank 33, the second tank 35, the third tank 37, the fourth tank, and the storage unit 32 are fluidly connected to a mixing unit 31.

The mixing unit 31 is configured to receive the first aqueous solution characterized by the first composition c1 and the second aqueous solution distinct from the first aqueous solution and characterized by the second composition c2, said first aqueous solution and said second aqueous solution being selected from the group composed of:
the industrial water solution 3,
the cationic ion exchange resin-treated water solution 5,
the demineralized water solution 7,
the aqueous solution containing Mg²⁺ and Ca²⁺ ions 9.

Moreover, the mixing unit 31 is configured to mix a first volume V1 of said first aqueous solution and a second volume V2 of said second aqueous solution, so as to make a mixing volume Vm1 of a mixture solution characterized by a mixture composition cm1 and forming all or part of the cooling water 1.

Said first volume V1 of the first aqueous solution and second volume V2 of the second aqueous solution being determined according to said first composition c1 and said second composition c2, and so that the mixture composition cm1 tends towards a predetermined target final composition cfc. As shown in FIG. 1, the mixing unit 31 may be configured to mix a number of volumes of aqueous solutions greater than two. The mixing unit 31 is further configured to receive and to mix a mass m of additive element with the mixture solution, said mass m of additive element being determined according to the first composition c1, the second composition c2, and the target final composition cfc.

According to a particular embodiment, the mixing unit 31 comprises a temperature control system 61 comprising a temperature sensor 63 configured to measure a mixing temperature corresponding to the temperature of the mixture solution. The temperature control system 61 is then configured to maintain the mixing temperature between 10° C. and 35° C., preferably between 12° C. and 30° C. The temperature control system 61 may be provided with heating means 65 configured to heat the mixing unit 31, when the mixing temperature is lower than or equal to 10° C. or 12° C. The temperature control system 61 may also comprise cooling means 67 configured to cool the mixing unit 31, when the mixing temperature is higher than or equal to 35° C. or 30° C.

In addition, the casting device 100 may advantageously comprise an analysis unit 60 configured to measure at least one useful parameter selected from the group comprising: a calcium concentration THCa, a magnesium concentration THMg, a M-alkalinity TAC, a P-alkalinity TA, a Hardness TH, and the pH. In particular, the analysis unit 60 may be used to implement the first analysis step E1 and the second analysis step E2 of the preparation method.

Finally, the casting device 100 may comprise a calculation unit 30 configured to determine the first volume V1 of the first aqueous solution and the second volume V2 of the second aqueous solution according to a useful parameter defining the first composition c1, a useful parameter defining the second composition c2, and so that a useful parameter defining the mixture composition cm1 tends towards a useful parameter defining the target final composition cfc. In general, the calculation unit is able to implement the calculation step E7 according to the embodiments described hereinbefore and hereinafter.

The preparation method and implementation thereof with the casting device 100 could be better understood on the basis of the examples given hereinbelow, given as a non-limiting example.

### Example 1

In this example, a cooling water 1 is prepared according to a target industrial water. Table 1 hereinbelow describes the composition of the industrial water solution 3 which could, for example, correspond to the first composition c1, and the target final composition cfc obtained during the first analysis step E1, and the second analysis step E2.

TABLE 1

| | | THCa/ | THCa | THMg | TA | TAC | CNa | CCl | CS | |
|---|---|---|---|---|---|---|---|---|---|---|
| | TH(° f.) | THMg | (° f.) | (° f.) | (° f.) | (° f.) | (mg/L) | (mg/L) | (mg/L) | pH |
| c1 | 41.1 | 5 | 34.3 | 6.9 | 0 | 38.0 | 60 | 80 | 49 | 7.1 |
| cfc | 48 | 2.5 | 37.5 | 14.3 | 0 | 14.7 | 46 | 100 | 280 | 7.4 |

In this example, the industrial water solution 3 characterized by the composition c1, has a high hardness, a high alkalinity and a high chloride ion content. This industrial water solution 3 may be stored in a first tank 33.

A portion of the industrial water solution 3 may then undergo a charging step E 32 when it flows in the cation exchanger comprising a weak cationic ion exchange resin 21 (the resin RESINEX KW-H, from the company Jacobi Carbons, Sweden). During this charging step E32, the industrial water solution 3 flows with a flow rate of 5 m³/h, then over a degasser during the degassing step E34. The degasser comprises a streaming column with counter-current air flow which is located above a second tank 35. Thus, in this second tank, the cationic ion exchange resin-treated water solution 5 which is then a decarbonated water having, in this example, a second composition c2. The second tank 35 may comprise means that allow fluidly connecting it to a reverse osmosis unit 27, in order to be able to supply the third tank 37 with demineralized water. According to this example, the reverse osmosis unit 27 comprises nine membranes and operates with a purge rate of 25%. This reverse osmosis unit 27 is able to produce between 1 m³/h and 2 m³/h of the demineralized water solution 7 during the demineralization step E41. Said demineralized water solution then has a composition c3 which is stored in a third tank 37.

When the weak resin 21 of the cation exchanger 20 is sufficiently charged during the charging step E32, the elution step E43 is implemented so as to produce the aqueous solution containing Mg²⁺ and Ca²⁺ ions 9 having a fourth composition c4, a portion of which will be stored in a fourth tank 39. For example, the elution step E43 may be implemented when a charge percentage of the weak resin 21 relative to the theoretical saturation calculated for the cation exchanger is comprised between 60% and 90% of the saturation.

According to one embodiment, the elution step E 43 comprises:
a thinning step in which industrial water 3 is introduced in counter-current, this thinning step allowing raising the resin grains and removing the accumulated impurities, typically a water flow rate of at least 5 m³/h is used
an elution step with a sulfuric acid solution at 4%, this solution being itself prepared by dilution using a doser pump of a commercial sulfuric acid solution at 20% with demineralized water. This step allows making the aqueous solution containing Mg²⁺ and Ca²⁺ ions 9.
a slow rinsing step (piston flow of the liquid) with demineralized water 7 in order to make a portion of the aqueous solution containing Mg²⁺ and Ca²⁺ ions 9 circulate towards the tank 39, and
a rapid rinsing step (turbulent flow of the liquid) with demineralized water solution 7, consisting in rapidly eliminating traces of acid 11 that would still be present.

In the particular case of this example, the use of weak cationic ion exchange resins 21 allows obtaining relatively low-acidity effluents which are simply neutralized by passage over a bed of calcium carbonate granules. As an acidic effluent, any water that is not used for making the casting water (1, 1a or 1b), the residues, a portion of the unused acid solution, rinses) is considered.

As indicated before, the industrial water solution 3 has a first composition c1 determined during the second analysis step E2. This first composition c1 of this industrial water solution 3 may be sufficiently stable over time so as not to require any additional second analysis steps E2.

In the particular case of this first example, the second, third, and fourth compositions c2, c3 and c4 may be deduced knowing the first composition of c1, as follows:

The cationic ion exchange resin-treated water solution 5 is obtained by decarbonation on a weak cationic ion exchange resin 21. The Na⁺ (sodium), Ca²⁺ (calcium) and Mg²⁺ (magnesium) cations bonded to the strong acid salts (sulfates and chlorides) are not retained and will be found in the cationic ion exchange resin-treated water solution 5 by passing through the cation exchanger 20, as well as all the anions (carbonates, bicarbonates). The cations retained by cation exchanger 20 (Mg²⁺ and Ca²⁺ bonded to the carbonates and bicarbonates) will be retained on the weak cationic ion exchange resin 21 and replaced by H₃O⁺ hydronium ions (2H₃O⁺ ions per Ca²⁺ ion or per Mg²⁺ ion). Hence, the second composition c2 in calcium and magnesium ions is calculated, in this case, from the total Hardness TH according to the following formula: TH (of the second composition c2)=TH (of the first composition c1)−TAC (of the first composition c1).

Hence, we obtain TH=3.1° f (41.1−38.0).

The calcium (THCa) and magnesium (THMg) values are calculated while assuming that the same ratio (herein THCa/THMg=5) as in the industrial water solution is preserved. Hence, THCa and THMg are calculated in the cationic ion exchange resin-treated water solution 5 by solving equations (1) and (2):

$$T HCa / THMg = 5 \qquad ( 1 )$$

$$THCa + THMg = T H = 3.1 \qquad ( 2 )$$

Upon solving this system, the values of Table 2 hereinbelow (THMg=0.5° f, and THCa=2.6° f, rounded values) are then obtained.

The TAC, obtained after the degasser, has been measured at 0.5° f at the outlet of the degasser.

This value is stable and is not measured at each mixture.

The demineralized water solution having the third composition c3 is produced by demineralization of the cationic ion exchange resin-treated water solution 5 during the demineralization step E41. It is possible to analyze the third composition c3 during a third analysis step consisting in measuring the conductivity of the solution. This third analysis step allows determining that the main ions have a concentration lower than 5 mg/L, except for sodium and chlorides (about 5 mg/L).

The fourth composition c4 of the aqueous solution containing Mg²⁺ and Ca²⁺ ions 9 depends on the acid concentration 11 used for regeneration of the weak cationic ion exchange resin 21. For example, the elution yield of the used cation exchanger estimated at 0.98 is taken into account. The 0.98 value corresponds to the elution yield of the used cation exchanger. The concentration of calcium and magnesium ions (from which TH is calculated) then corresponds at the beginning of the elution step E43, to 0.98 times the concentration (in moles or in ° f) of sulfuric acid. This sulfuric acd concentration may be controlled by measurements of acid and water flow rates and an on-line measurement of conductivity. It may be provided to keep only the eluate at the beginning of the elution step E43, and within the limit of the capacity of the fourth tank 39. Hence, according to this protocol, the aqueous solution containing Mg²⁺ and Ca²⁺ ions 9 has a constant fourth composition c4 which may be determined only once for the implementation of the second analysis step E2 on the aqueous solution containing Mg²⁺ and Ca²⁺ ions 9.

TABLE 2

| | TH | THCa/ | THCa | THMg | TAC | CNa | CCl | CS | | Conductivity |
|---|---|---|---|---|---|---|---|---|---|---|
| | (° f.) | THMg | (° f.) | (° f.) | (° f.) | (mg/L) | (mg/L) | (mg/L) | pH | (μS/cm) |
| c1 | 41.1 | 5 | 34.3 | 6.9 | 38.0 | 60 | 80 | 49 | 7.1 | 900 |
| c2 | 3.1 | 5 | 0.5 | 2.6 | 0.5 | 60 | 80 | 49 | | 750 |
| c3 | <0.1 | | <0.1 | <0.1 | <0.1 | 5 | 5 | <5 | | 50 |
| c4 | 154 | 5 | 128 | 26 | 0 | 0 | 100 | 1,470 | | >3,000 |

The following relationships prevail between TH, THCa, THMg and R=THCa/THMg.

$$TH = THCa + THMg$$

$$THCa = R . TH / ( 1 + R )$$

$$THMg = TH / ( 1 + R )$$

The steps E51 of providing at least one additive and dilution element E53 allows forming additive solutions with compositions a1, a2, a3, a4, and a5 corresponding to the dilution of the mass m1 of salt, or the mass m2 of pH corrector in a volume of demineralized water solution 7 so as to provide an additive solution of MgSO₄ (at 10%) defined by a composition a1, an additive solution of MgCl₂ (at 10%) defined by a composition a2, an additive solution of NaHCO₃ (at 8%) defined by a composition a3, and an additive solution of NaOH (at 5%) defined by a composition a4. The sulfuric acid solution at 20% used to regenerate the cation exchangers 20 is stored in a tank 3 m3.

It may also serve as an additive solution defined by a composition a5.

The chemical compositions a1, a2, a3, a4, and a5 of the additive solutions are described with the same formalism as the previous four aqueous solutions, the parameters TH and the ratio R=THCa/THMg being replaced by THCa and THMg, to avoid divergent calculations when THCa=0, or THMg=0.

TABLE 3

| | TH | | | TAC | CNa | CCl | CS |
|---|---|---|---|---|---|---|---|
| | (° f.) | THCa | THMg | (° f.) | (mg/L) | (mg/L) | (mg/L) |
| MgSO4 (a1) | 9,110 | 0 | 9,110 | 0 | 0 | 0 | 87,781 |
| CaCl2 (a2) | 10,016 | 10,016 | — | — | — | 69,936 | — |
| NaHCO3 (a3) | — | — | — | 5,240 | 24,095 | — | — |
| H2SO4 (a4) | — | — | — | — | — | — | 215,510 |
| NaOH (a5) | — | — | — | — | 31,625 | — | — |

From the available aqueous solutions of compositions c1, c2, c3, and c4, the target final of composition cfc, and the chemical compositions of the additive solutions a1, a2, a3, a4, and a5, it is possible to implement the calculation step E7.

The mixture composition cm1 of the mixture solution, for a volume Vm1 (known), is then described by the following equation, which is declined for each useful parameter of each composition (for example THCa, THMg, TAC, Sodium, Chlorides, Sulfates). Hence, in this case, 6 equations corresponding to 6 different useful parameters are obtained:

$$ci . Vm 1 = V 1. c 1 i + V 2. c 2 i + V 3. c 3 i + V 4. c 4 i + Va 1. a 1 i + Va 2. a 2 i + Va 3. a 3 i + Va 4. a 4 i + Va 5. a 5 i .$$

The index i in the previous formula refers to the 6 useful parameters described in this example (THCa, THMg, TAC, CNa, CCI, CS).

We have Vm1=V1+V2+V3+V4+Va1+Va2+Va3+Va4+Va5, where V1, V2, V3 and V4 correspond to the volumes to be mixed of aqueous solutions of compositions c1, c2, c3, and c4 and Va1, Va2, Va3, Va4, and Va5 correspond to the volumes to be mixed of the additive solutions of compositions a1, a2, a3, a4, a5.

In the case of this first example, the following parameters Vm1 and c1i, c2i, c3i, c4i, a1i, a2i, a3i, a4i, a5i are known:
Vm1 corresponds to the volume of cooling water to be made. It is also possible to use flow rates by dividing the volumes by a unit of time. This parameter is defined by one single value. For this example, 24 m³ of cooling water solution is required. This flow rate value is 2.4 m³/h if the characteristic time is 10 h (time interval between each casting for example).
c1i, c2i, c3i, c4i, a1i, a2i, a3i, a4i, a5i: correspond respectively to the useful parameters of the available aqueous solutions (3, 5, 7, 9), and of the available additive solutions of salts 13 and pH correctors 15. Complementary analysis steps may possibly be implemented to control each useful parameter.

According to a non-limiting variant, a weighting coefficient γi may be used to prioritize one of the useful parameters. In this example, for example, a greater importance is given to the concentration of magnesium THMg compared to the concentration of sodium CNa or to the concentration of sulfate ions CS. Hence, the following weighting coefficients γi are selected, allowing obtaining the following mixture composition cm1 (Table 4):

TABLE 4

| | THCa | THMg | TAC | CNa | CCl | CS |
|---|---|---|---|---|---|---|
| | (° f.) | (° f.) | (° f.) | (mg/L) | (mg/L) | (mg/L) |
| c1 | 34.3 | 6.9 | 38.0 | 60 | 80 | 49 |
| [symbol] i | 100 | 2,000 | 50 | 2 | 200 | 1 |
| cfc | 35.7 | 14.3 | 14.7 | 46 | 100 | 300 |
| cm1 | 35.7 | 14.3 | 14.7 | 46 | 100 | 300 |

In the context of this example and the selected weights, it is possible to obtain a mixture solution having a mixture composition cm1 equal to the target final composition cfc. However, such a solution is not always mathematically obtained given the elements available during the preparation process.

Hence, the calculation step E7 comprises afterwards determining the volumes to be mixed. In this example, the unknowns are the 9 volumes of the solutions to be mixed (V1, V2, V3, V4, Va1, Va2, Va3, Va4, Va5). The calculation unit 30 then uses a solver which allows minimizing the sum of the following deviations:

$${\sum }_{i = 1 = > 6 γ i} . {[ ( V 1. c {1}_{i} + V 2. c {2}_{i} + V 3. c {3}_{i} + V 4. c {4}_{i} + \\ Va 1. a {1}_{i} + Va 2. a {2}_{i} + Va 3. a {3}_{i} + Va 4. a {4}_{i} + Va 5. a {5}_{i} ) - Vm 1. cm {1}_{i} ]}^{2}$$

In order to obtain mathematical solutions that have a physical meaning, desired boundary conditions are added (i.e. all values are positive, the volumes cannot be larger than the capacity of the tanks 33, 35, 37, 39) so as to obtain the volumes of each solution to be added, as well as the mixture composition cm1 of the mixture solution.

In the context of this particular example, a volume Vm1 of 24 m3 of the mixture solution may be obtained by mixing the following volumes:
V1 (industrial water solution 3)=9.28 m³
V2 (cationic ion exchange resin-treated water solution 5)=9.10 m³
V3 (demineralized water solution 7)=2.64 m³
V4 (aqueous solution containing Mg2+ and Ca2+ ions 9)=2.98 m³

And with the following additives:
Va1 (a MgSO4 solution at 10%)=21.7 L
Va2 (a CaCl2 solution at 10%)=13.3 L
Va3, Va4 and Va5 are not used (═O).

The mixing phase P3 then comprises only a first mixing step E8 by mixing in a mixing unit 31 the calculated volumes corresponding to the different solutions. For example, the first step E8 of mixing the aqueous solutions may be carried out in the following order: V1, V2, V3, V4, by means of a magnetic stirrer, then by adding the volumes of additive solutions Va1 and Va2 while keeping stirring.

Afterwards, the preparation method may comprise the control step E9 in which a control of the obtained mixture composition cm1 is carried out. This control comprises:
measuring the hydrotimetric level TH and of the complete alkaline level TAC using a color indicator TH and TAC analyzer
measuring the pH by a pH probe.

Depending on the result of the control step E9, the pH may be corrected afterwards by the addition of bleach water to obtain a desired amount of free chlorine so that the mixture composition cm1 tends towards the target final composition cfc.

### Example 2

In this second example, Table 5 hereinbelow describes the composition of the industrial water solution which could, for example, correspond to the first composition c1, and also describes the target final composition cfc. These two compositions are obtained during the first analysis step E1, and the second analysis step E2. In particular, in the implementation of the preparation method of this example, the aim is to obtain a cooling water 1 for which the useful parameters “hydrotimetric ratio and complete alkaline level TAC” are lower than the corresponding useful parameters corresponding to the target final composition cfc.

TABLE 5

| | TH | THCa/ | THCa | THMg | TA | TAC | CNa | CCl | CS | |
|---|---|---|---|---|---|---|---|---|---|---|
| | (° f.) | THMg | (° f.) | (° f.) | (° f.) | (° f.) | (mg/L) | (mg/L) | (mg/L) | pH |
| c1 | 17 | 3 | 12.8 | 4.3 | 0 | 9.0 | 12 | 43 | 44 | 7.4 |
| cfc | 8.5 | 2 | 5.7 | 2.8 | 0 | 4.0 | 10 | 33 | 19 | 7.0 |

According to this example, the preparation device 50 comprises a reverse osmosis element 27, connected to the first tank 33, but does not comprise a cation exchanger 20. Hence, it is possible to make two aqueous solutions characterized by two compositions:
the industrial water solution 3 characterized by the first composition c1; and
the demineralized water solution 7 characterized by a second composition c2.

The industrial water solution 3, for example stored in the first tank 33, or available directly on site, feeds the reverse osmosis unit 27, which allows producing the demineralized water solution 7 by the step E41 of demineralizing a portion of the industrial water solution 3, then storing it in the third tank 37.

Advantageously, the industrial water solution 3 used to produce the demineralized water solution 7 is filtered by a filter having a filtration mesh of 5 μm. This allows avoiding fouling of the membranes (in particular at the spacers) and increases their service life. Advantageously, a sequestering product based on polyphosphates is continuously injected. This allows avoiding the precipitation of the calcium ions in the presence of carbonates in the concentration loop of the reverse osmosis unit 27.

In the context of this example, the industrial water solution 3 stored in the first tank 33 may have a composition c1 which varies, in particular, according to the apparatuses using this water, the season, and the operation of the temperature control system 61. Thus, it may be provided to implement one or more second analysis step(s) E2 in order to determine at all times a good estimate of the first composition c1 of this stored industrial water solution 3.

Unlike the industrial water solution 3, the demineralized water solution 7 has a substantially constant and known composition c2. Hence, it is not necessary to carry out a second analysis step E2 at each demineralization step E41. An on-line conductivity control is sufficient to ensure proper operation of the osmosis unit and the constant quality of the water. Table 6 hereinbelow details the first and second compositions c1, c2 of the industrial water 3 and demineralized water 7 solutions.

TABLE 6

| | TH | THCa/ | THCa | THMg | TAC | CNa | CCl | CS | | Conductivity |
|---|---|---|---|---|---|---|---|---|---|---|
| | (° f.) | THMg | (° f.) | (° f.) | (° f.) | (mg/L) | (mg/L) | (mg/L) | pH | μS/cm |
| c1 | 17 | 3 | 12.8 | 4.3 | 9.0 | 12 | 44 | 44 | 7.4 | 600 |
| c2 | <0.1 | | <0.1 | <0.1 | <0.1 | 5 | 5 | <5 | | 20 |

From the available aqueous solutions and from the target final composition cfc, it is possible to implement the calculation step E7. In this example, it is not possible to use any aqueous solution other than that mentioned hereinabove, or to use additive elements.

The mixture composition of the mixture solution cm1, for a volume Vm1 (known), is then described by the following equation, which has a declination for each useful parameter of each composition (for example THCa, THMg, TAC, Sodium, Chlorides, Sulfates). Hence, in this case, 6 equations corresponding to 6 different useful parameters are obtained:

$$ci . Vm 1 = V 1. c 1 i + V 2. c 2 i ,$$

The index i referring to the 6 useful parameters described in this example (THCa, THMg, TAC, CNa, CCI, CS), with Vm1=V1+V2.

In the case of this first example, the following parameters are known:
Vm1: volume of the solution to be made;
c1i, c2i: which correspond respectively to the useful parameters of the available aqueous solutions (3, 7).

According to a non-limiting variant, a weighting coefficient γi may be used to prioritize one of the useful parameters. In this example, for example, a greater importance is given to the magnesium concentration THMg and to the calcium concentration THCa compared to the other useful parameters. Hence, the following weighting coefficients γi are selected, allowing obtaining the following mixture composition cm1 (Table 7):

TABLE 7

| | THCa | THMg | TAC | CNa | CCl | CS |
|---|---|---|---|---|---|---|
| | (° f.) | (° f.) | (° f.) | (mg/L) | (mg/L) | (mg/L) |
| c1 | 12.8 | 4.3 | 9.0 | 12 | 44 | 44 |
| γi | 200 | 200 | 20 | 2 | 20 | 1 |
| cfc | 5.7 | 2.8 | 4.0 | 10 | 33 | 19 |
| Cm1 | 6.4 | 2.1 | 4.5 | 6 | 22 | 22 |

Hence, the calculation step E7 comprises afterwards determining the volumes to be mixed. In this example, the unknowns are the 2 volumes of the aqueous solutions to be mixed V1, V2.

The calculation unit 30 then uses a solver which allows minimizing the sum of the following deviations:

$${\sum }_{i = 1 = > 6 γ i} . {[ ( V 1. c {1}_{i} + V 2. c {2}_{i} ) - Vm 1. cm {1}_{i} ]}^{2}$$

In order to obtain actual solutions, desired boundary conditions are added. For example, all of the values are positive, the volumes cannot be larger than the capacity of the reservoirs 33, 37 so as to obtain the volumes of each solution to be added as well as the mixture composition cm1 of the mixture solution.

In this particular case, given the available aqueous solutions, it is not possible to obtain exactly the target final composition cfc. Nevertheless, it is possible to obtain a mixture solution volume Vm1 meeting the fixed objectives of the preparation method by choosing to mix the industrial solution 3 (V1=50% Vm1) and the demineralized solution 7 (V2=50% Vm1) fifty-fifty.

1. A method for preparing a cooling water (1) for cooling a product during a metallurgical transformation operation and in particular for semi-continuous casting applications of cast products, the preparation method comprising the following steps:
a step (E1) of analyzing the composition of a target cooling water so as to determine a target final composition (cfc),
a step (E6) of providing at least one first aqueous solution characterized by a first composition (c1) and at least one second aqueous solution distinct from the first aqueous solution and characterized by a second composition (c2), said first aqueous solution and said second aqueous solution being selected from the group composed of:
an industrial water solution (3) with a conductivity lower than or equal to 2,000 μS/cm with a hardness lower than or equal to 80° f (French degree),
a cationic ion exchange resin-treated water solution (5) with a conductivity higher than or equal to 100 μS/cm, which is either a decarbonated water such as TH₅≤TAC₅+3° f, or a permuted water such as TH₅≤3° f, where TH₅ and TAC₅ are respectively the hardness and the P-alkalinity of the cationic ion exchange resin-treated water solution (5) considered in French degree ° f,
a demineralized water solution (7) with a conductivity lower than or equal to 100 μS/cm,
an aqueous solution containing Mg²⁺ and Ca²⁺ ions (9), with conductivity higher than or equal to 20 μS/cm, such that its hardness TH₉ is higher than 50° f,
a mixing phase (P3) comprising a first mixing step (E8) in which a first volume (V1) of the first aqueous solution and a second volume (V2) of the second aqueous solution are mixed, so as to make a mixing volume (Vm1) of a mixture solution characterized by a mixture composition (cm1), and forming all or part of the cooling water (1), said first volume (V1) of the first aqueous solution and second volume (V2) of the second aqueous solution being determined by a calculation step (E7) according to said first composition (c1) and said second composition (c2),
and wherein each of the first composition (c1), the second composition (c2), the mixture composition (cm1), and the target final composition (cfc), is defined by at least one useful parameter selected from the group comprising a calcium concentration (THCa), a magnesium concentration (THMg), a M-alkalinity (TAC), a P-alkalinity (TA), a Hardness (TH), a concentration of chlorides (CCI), sulfates (CS), bromides (CBr), sodium (CNa) ions and a pH;
said calculation step (E7) in which the first volume (V1) of the first aqueous solution and the second volume (V2) of the second aqueous solution are determined according to said at least one useful parameter defining the first composition (c1), said at least one useful parameter defining the second composition (c2), and so that said at least one useful parameter defining the mixture composition (cm1) tends towards said at least one useful parameter defining the target final composition (cfc).

2. The method according to claim 1, wherein the calculation step (E7) is implemented by a calculation unit (30) configured to calculate the first volume (V1) of the first aqueous solution and the second volume (V2) of the second aqueous solution so as to minimize a difference between said at least one useful parameter defining the mixture composition (cm1) and said at least one useful parameter defining the target final composition (cfc).

3. The method according to claim 1, further comprising a step (E51) of providing at least one additive element selected from the group comprising salts (13) and pH correctors (15), the first mixing step (E8) further comprising mixing an additive element mass (m), said additive element mass (m) being determined according to the first composition (c1) and the second composition (c2), and the target final composition (cfc).

4. The method according to claim 1, wherein the cationic ion exchange resin-treated water solution (5) is a decarbonated water obtained according to the following steps:
a step (E30) of providing a cation exchanger (20) comprising a weak cationic ion exchange resin (21), said cation exchanger (20) being configured to vary between a regenerated configuration in which said weak cationic ion exchange resin (21) is able to capture calcium Ca²⁺ or magnesium Mg²⁺ divalent cations and a charged configuration in which said weak cationic ion exchange resin (21) forms a reserve of calcium Ca²⁺ or magnesium Mg²⁺ divalent cations;
a weak cationic ion exchange resin absorption step (E32) in which a portion of the industrial water solution (3) flows in the cation exchanger (20) comprising the weak cationic ion exchange resin (21) to make it vary from the regenerated configuration into the charged configuration;
a degassing step (E34) in which a water coming out of the cation exchanger (20) is degassed, so as to obtain the decarbonated water such that TH₅≤TAC₅+2° f where TH₅ and TAC₅ are respectively the Hardness and the P-alkalinity of the decarbonated solution expressed in French degree.

5. The method according to claim 1, wherein the cationic ion exchange resin-treated water solution (5) is permuted water, obtained according to the following steps:
a step (E31) of providing a cation exchanger (20) comprising a strong cationic ion exchange resin (23), said cation exchanger (20) being configured to vary between a regenerated configuration in which said strong cationic ion exchange resin (23) is able to capture calcium Ca²⁺ or magnesium Mg²⁺ divalent cations and a charged configuration in which said strong cationic ion exchange resin (23) forms a reserve of calcium Ca²⁺ or magnesium Mg²⁺ divalent cations;
a strong cationic ion exchange resin absorption step (E33) in which a portion of the industrial water solution (3) flows in the cation exchanger (20) comprising the strong cationic ion exchange resin (23) to make it vary from the regenerated configuration into the charged configuration, and so as to obtain the permuted water such that TH5≤TAC5 where TH₅ and TAC₅ are respectively the Hardness and the P-alkalinity of the permuted solution expressed in French degree.

6. The method according to claim 4, wherein the demineralized water solution (7) is obtained by a demineralization step (E41) in which a portion of the decarbonated water or permuted water solution is demineralized by a reverse osmosis or ion-exchange process on a demineralization resin (25) so as to obtain the demineralized water solution (7) with a conductivity lower than or equal to 100 μS/cm.

7. The method according to claim 4, wherein the aqueous solution containing Mg²⁺ and Ca²⁺ ions (9) is obtained during an elution step (E43) in which a strong acid (11) is circulated in the cation exchanger (20), so that Mg²⁺ and Ca²⁺ ions captured by the weak cationic ion exchange resin (21) or by the strong cationic ion exchange resin (23) are dissolved, so as to make the aqueous solution containing Mg²⁺ and Ca²⁺ ions (9) with a conductivity higher than or equal to 20 μS/cm, such that its Hardness TH₉ is higher than 50° f.

8. The method according to claim 7, wherein the strong acid (11) is sulfuric acid.

9. The method according to claim 7, wherein the elution step (E43) is implemented after the weak cationic ion exchange resin absorption step (E32) or after the strong cationic ion exchange resin absorption step (E33).

10. A use of a cooling water (1) obtained according to the method of claim 1 for cooling a product in a metallurgical transformation step, such as casting, or quenching, or hot rolling.

11. A method for casting a product, preferably made of an aluminum alloy comprising the following steps:
(a) preparing a liquid metal bath, preferably made of aluminum alloy comprising, in weight %, Cu: 0-6.0; Mg: 0-8; Si 0-12; Zn 0-12; others≤3 each and ≤10 in total, the remainder aluminum,
(b) casting said liquid metal by vertical semi-continuous casting such that, during a casting start phase, a first cooling water (1a) characterized by a first mixture composition (cma) obtained according to the method according to claim 1 is used.

12. The method according to claim 11, comprising a steady-state casting phase (c) upon completion of the casting start phase and such that, during the steady-state casting phase (c), a second cooling water (1b), characterized by a second composition (cfb), different from the first cooling water (1a), is used, optionally this second cooling water (1b) is obtained according to the method according to claim 1.

13. A casting device (100) comprising a device (50) for preparing a cooling water (1), said preparation device (50) comprising:
an analysis unit (60) configured to measure at least one useful parameter selected from the group comprising: a calcium concentration (THCa), a magnesium concentration (THMg), a M-alkalinity (TAC), a P-alkalinity (TA), a Hardness (TH), and the pH,
a calculation unit (30) configured to determine the first volume (V1) of the first aqueous solution and the second volume (V2) of the second aqueous solution according to a useful parameter defining the first composition (c1), a useful parameter defining the second composition (c2), and so that a useful parameter defining the mixture composition (cm1) tends towards a useful parameter defining the target final composition (cfc),
a cation exchanger (20) comprising an active material, said cation exchanger (20) being configured to vary between a charged configuration in which calcium Ca²⁺ or magnesium Mg²⁺ divalent cations are bonded to the active material, and a regenerated configuration in which the active material is able to capture calcium Ca²⁺ or magnesium Mg²⁺ divalent cations, said cation exchanger (20) comprising means allowing connecting it to the mixing unit (31), preferably said cation exchanger (20) comprises a weak cationic ion exchange resin (21) or a strong cationic ion exchange resin (23),
a mixing unit (31) configured to receive a first aqueous solution characterized by a first composition (c1) and a second aqueous solution distinct from the first aqueous solution and characterized by a second composition (c2), said first aqueous solution and said second aqueous solution being selected from the group composed of:
an industrial water solution (3),
a cationic ion exchange resin-treated water solution (5),
a demineralized water solution (7),
an aqueous solution containing Mg²⁺ et Ca²⁺ ions (9), said mixing unit (31) being further configured to mix a first volume (V1) of said first aqueous solution and a second volume (V2) of said second aqueous solution, so as to make a mixing volume (Vm1) of a mixture solution characterized by a mixture composition (cm1) and forming all or part of the cooling water (1), said first volume (V1) of the first aqueous solution and second volume (V2) of the second aqueous solution being determined according to said first composition (c1) and said second composition (c2), and so that the mixture composition (cm1) tends towards a predetermined target final composition (cfc).

14. The device (100) according to claim 13, further comprising a reverse osmosis unit (27) or a demineralization resin ion exchanger (25), said reverse osmosis unit (27) or said demineralization resin ion exchanger (25) comprising means allowing connecting it to the mixing unit (31) and the cation exchanger (20).

15. The device (100) according to claim 13, wherein the mixing unit (31) comprises a temperature control system (61) comprising a temperature sensor (63) configured to measure a mixing temperature corresponding to the temperature of the mixture solution, said temperature control system (61) being configured to maintain the mixing temperature between 10° C. and 35° C., preferably between 12° C. and 30° C.
